(19) United States
(12) Patent Application Publication
(10) Pub. No.: US 2017/0258664 A1
(43) Pub. Date: Sep. 14, 2017

(54) UPRIGHT WALKER HAVING A USER SAFETY SYSTEM EMPLOYING HAPTIC FEEDBACK

(71) Applicant: Protostar, Inc., a Delaware Corporation, San Diego, CA (US)

(72) Inventor: David A. Purcell, San Diego, CA (US)

(73) Assignee: Protostar, Inc., a Delaware Corporation, San Diego, CA (US)

(21) Appl. No.: 15/415,879

(22) Filed: Jan. 26, 2017

Related U.S. Application Data
(60) Provisional application No. 62/308,050, filed on Mar. 14, 2016.

(51) Int. Cl. A61H 3/04

(52) U.S. Cl. CPC A61H 3/04; A61H 2003/046; A61H 2003/006

(57) ABSTRACT

An upright wheeled walker with bilateral stabilizing wheel suspensions, and an automatic braking system integrated with obstacle avoidance systems, terrain sensors and user feedback controls. The walker provides user upper body weight support in a wheeled walker with a user safety system including a plurality of sensor, processor and control elements and an automatic braking system for avoiding unseen obstacles and automatic speed limiting on inclines.

### CROSS-REFERENCES TO RELATED APPLICATIONS

This application is filed under 35 U.S.C. §111(a) pursuant to 37 C.F.R. §1.53(b) claiming the benefit under 35 U.S.C. §119(e) of Provisional Patent Application No. 62/308,050 filed on Mar. 14, 2016, which is entirely incorporated herein by reference.

This application is related by common inventorship and subject matter to the commonly-assigned U.S. patent application Ser. No. 15/012,784 filed on Feb. 1, 2016, which is entirely incorporated herein by reference.

This application is related by common inventorship and subject matter to the commonly-assigned U.S. patent application Ser. No. 15/148,993 filed on May 6, 2016, now U.S. Pat. No.______, which is entirely incorporated herein by reference.

### BACKGROUND OF THE INVENTION

1. Field of the Invention

This invention relates generally to mobility-assistance devices and more particularly to a smart upright walker that facilitates a natural upright gait and provides haptic signaling to the user responsive to obstacle sensor signals.

2. Description of the Related Art

Assistive mobility devices, including walkers, are well-known in the art as useful means for reducing the disadvantages of mobility limitations suffered by many people, permitting more efficient ambulation over distance and thereby increased independence. Data from the National Long Term Care Survey suggests that increased use of assistive technology may have helped reduce disability at older ages [Manton, et al., Changes in the Use of Personal Assistance and Special Equipment from 1982 to 1989: Results from the 1982 and 1989 NLTCS, Gerontologist 33(2):168-76 (April 1993)]. Although mobility device users represent a relatively small minority of the population with disabilities, their importance transcends their numbers because mobility devices are visible signs of disability and have become symbols of the very idea of disability. And the mobility-impaired population is increasing much faster than the general population [LaPlante et al., Demographics and Trends in Wheeled Mobility Equipment Use and Accessibility in the Community, Assistive Technology, 22, 3-17, (2010)]. Accordingly, there has long been a growing demand in the U.S. and throughout the world for improved mobility assistance devices adaptable for improving ambulation for rapidly growing numbers of mobility-limited persons.

Martins et al. [Martins et al., Assistive Mobility Devices focusing on Smart Walkers: Classification and Review, Robotics and Autonomous Systems 60 (4), April 2012, pp. 548-562] classify mobility assistance devices as Alternative Devices (for users with total in-capacity) and Augmentative Devices (for users with residual mobility). Mobility and manipulation are critical to living independently and are often strongly associated with the ability to continue to live safely in one's home. Simple augmentative devices such as walkers and rollators (wheeled walkers) can assist an impaired person who has the endurance and strength to walk distances, but many also need some support and feedback to avoid loss of balance and to enable the person to rest when necessary. Although the impaired individual eventually may be obliged to use more elaborate alternative devices such as wheelchairs and powered mobility devices, most people strongly desire to retain the independence of a simpler augmentative device for as long as possible. For this reason, there is a well-known need for improvements that permit the simpler wheeled walker to facilitate the natural upright ambulation of progressively larger numbers of impaired individuals.

Of the many different solutions proposed by practitioners of the art, an important approach to mobility assistance is the so-called Smart Walker. By allowing the user varying degrees of control, from complete to collaborative, these intelligent wheeled walkers afford the user with the feeling of control, while improving the ease and safety of their daily travels. The control systems of these walkers differ from those of other mobility aids and robots because they must both assist mobility and provide balance and support. See, for example, Wasson et al., Effective Shared Control in Cooperative Mobility Aids, Proc. 14th Int. Florida Artificial Intelligence Research Society Conf May 2001, pp. 5509-518.

Although popular, the most common augmentative devices known in the art have many well-known disadvantages; even for relatively capable individuals. The typical wheeled walker known in the art has many well-known disadvantages; such as requiring a stooping or a forward leaning posture and a hobbled gait, difficulty in smooth transition of irregular terrain, offering little or no upper body and arm support, and requiring significant hand and arm strength to maneuver and operate the hand brakes when available, for example. Obliging the user to stoop over and lean forward to use a walker, which stresses the user's back and arms, also risks tipping forward when encountering obstacles. And most wheeled devices known in the art have one or more supports without wheels or with wheels too small to safely negotiate even small surface irregularities. Some devices are too heavy and awkward for an unassisted impaired user to lift into a car trunk or van, which limits independent unassisted use. Wheeled walker brakes are often either nonexistent or ineffective for the unassisted impaired user, which risks falls and injury and limits independence.

The typical wheeled walker known in the art is neither designed nor intended to support significant user weight during use for walking. Both designer and user assume without critical thought that the wheeled walker purpose is simply to provide assistance in balance and gait; like an elaborate cane system. So the user is generally obliged to reach down and engage the walker with hands and wrists alone, often with a stooping or leaning posture. The impaired user generally lacks the hand and wrist strength needed to continuously support significant upper body weight while walking in a stooped or forward-leaning position. The mobility assistance art is replete with suggestions for improving wheeled walkers to mitigate one or more of these well-known problems.

For example, in U.S. Pat. No. 8,100,415, Kindberg et al. disclose a wheel suspension that facilitates curb climbing when used with large wheels in, for example, a rollator. But Kindberg et al. limit their teachings to negotiating uneven terrain such as curbs. In U.S. Pat. No. D561,065, Kindberg et al. also disclose a walker frame design.

And, for example, in U.S. Pat. No. 8,840,124, Serhan et al. disclose a safety brake in a rollator that improves the safety of seated users by using a braking system that locks the rollator wheels when the user sits down on the rollator seat, and releases the wheels when the user stands up. As another example, in U.S. Pat. No. 7,052,030, Serhan discloses a wheeled walker with cross-member supports adapted to permit both seat and basket with wheel sizes greater than seven to eight inches. In U.S. Pat. No. 6,886,575, Diamond discloses a locking assembly for use with a walker having foldable side members. And, for example, in U.S. Pat. No. 8,678,425, Schaaper et al. disclose a wheelchair having a moveable seat element facilitating use as a rollator.

In U.S. Pat. No. 8,740,242, Slomp discloses a posterior walker configured to encourage a neutral spine during use. And, for example, in U.S. Pat. No. 7,559,560, Li et al. discloses a rollator having a foldable seat element.

Some practitioners propose improving the walker mobility aid by adding upper support means for supporting the user's forearms, hands or shoulders to improve user comfort and posture. For example, in U.S. Pat. No. 5,657,783, Sisko et al. disclose accessory forearm rests that may be mounted to any conventional invalid walker, preferably disposed above the normal hand-grips to provide support for the user's arms.

Such an upright wheeled walker may permit the user to walk upright but the wheeled walker known in the art is not adapted to support any user body weight beyond the relatively small portion in the forearms and hands. For example, in U.S. Pat. No. 8,540,256, Simpson discloses a walker with a forearm support frame to permit an upright user to step forward with the walker footprint but little weight bearing capacity.

Introducing ergonomic upper-body support in a wheeled walker is advantageous because it facilitates better walking and standing posture, improved gait and comfort. But adding significant user body weight to the wheeled walker during use is also disadvantageous because the increased weight borne on each wheel during use affects walker stability, braking, and terrain handling, all functions that affect user safety. For example, adding significant upright weight support to the wheeled walker introduces the new disadvantages of lateral and longitudinal instability during use and thus imperils user safety. Any wheeled walker has longitudinal stability problems when rolling on slopes and over irregular terrain, which may imperil user safety by causing falls during use. This longitudinal instability problem is exacerbated by adding upright weight support because of increased wheel loads imposed by the applied user weight, which not only increases unwanted longitudinal instability but introduces a new lateral instability arising from alternating wheel load fluctuations created by the stepping of a weight-supported user.

Instead of proposing solutions to these new stability problems, practitioners have generally offered various powered vehicles to facilitate some weight-bearing in assistive devices with sufficient weight and stability for user safety. For example, in U.S. Pat. No. 8,794,252, Alghazi discloses a mobility apparatus with an integrated power source and four wheels so a user can stand on it and drive it as an electric mobility device, or disable it and use it as a passive walker. His device is collapsible and includes a pair of supporting beams disposed to support the user weight under the armpits, but such support does little to improve user posture or stability.

Similarly, for example, in U.S. Pat. No. 8,234,009, Kitahama discloses an autonomous mobile apparatus that moves autonomously along near a specified person (user) while detecting and evaluating the surroundings to assess the danger level to the user, moving as necessary to avoid danger to the user based on the danger level detected. But such devices are generally perceived as alternative devices (such as powered wheel chairs, stair climbers and vehicles) by the user and do not represent improvements to the assistive devices preferred by most users.

In U.S. Pat. No. 7,708,120, Einbinder discloses a useful improvement to user safety consisting of a walker braking system using a controller and electrically actuated wheel brakes to provide push-button user control over braking and processor-controlled braking responsive to, for example, user hand position and the terrain slope. But Einbinder limits his teachings to braking control systems and neither considers nor suggests upright posture, weight-support, lateral stability nor haptic user feedback.

These and other examples of the mobility assistance art demonstrate that there is a continuing long-felt need for improved solutions to the walking posture, upper body weight support and user safety problems discussed above.

These unresolved problems and deficiencies are clearly felt in the art and are solved by this invention in the manner described below.

### SUMMARY OF THE INVENTION

This invention solves the walking posture, upper body weight support and user safety problems by introducing for the first time an upright wheeled walker with bilateral stabilizing wheel suspensions, and an automatic braking system integrated with obstacle avoidance systems, terrain sensors and user feedback controls.

It is an advantage of the walker of this invention that it provides significant user upper body support in a wheeled walker without lateral or longitudinal instability.

It is a purpose of the walker of this invention to provide user upper body weight support in a wheeled walker with an automatic braking system for avoiding unseen obstacles and automatic speed control on inclines.

It is an advantage of the walker of this invention that it provides automatic braking upon detection of the user departing from the user footprint when, for example, releasing the handles.

It is a purpose of the walker of this invention to provide user upper body weight support in a wheeled walker with an automatic tactile feedback to the user signaling the presence of obstacles or hazards.

It is a purpose of this invention to provide an upright wheeled walker that improves posture and comfort while also improving stability and safety through new automatic braking features and an intuitive haptic control system that facilitates safe use by users who may be otherwise too impaired to safely use the assistive motility devices known in the art.

In one aspect, the invention is a wheeled walker for a user having one or more hands and forearms, comprising a frame having a front and a rear, an upper body support assembly coupled to the frame, including gutter means for supporting the one or more user forearms, and handle means for touching by the one or more user hands, a plurality of wheel assemblies coupled to the frame and disposed to support the frame on a surface and to define a polygonal footprint on the surface, each wheel assembly disposed at a vertex of the polygonal footprint and including one or more rear wheel assemblies each including a wheel disposed generally at the rear of the frame, and one or more front wheel assemblies each including a wheel disposed generally at the front of the frame, at least one sensor disposed to produce an obstacle detection signal responsive to the presence of an obstacle in the vicinity of the wheeled walker, a signal processor coupled to the sensor for producing a user alert signal responsive to the obstacle detection signal, and at least one kinetic motor coupled to the processor and disposed in the upper body support assembly to produce a haptic sensation in the user responsive to the user alert signal.

The foregoing, together with other objects, features and advantages of this invention, can be better appreciated with reference to the following specification, claims and the accompanying drawing.

### BRIEF DESCRIPTION OF THE DRAWINGS

For a more complete understanding of this invention, reference is now made to the following detailed description of the embodiments as illustrated in the accompanying drawing, in which like reference designations represent like features throughout the several views and wherein:

FIG. 1 is an oblique view of a first exemplary embodiment of the upright wheeled walker of this invention having four wheel assemblies each defining one of the four vertices of a polygonal walker footprint;

FIG. 2 is a functional block diagram showing an exemplary embodiment of a walker control system, including exemplary sensor, processor, controller and kinetic motor signal embodiments, suitable for use with the walker of this invention;

FIG. 3 is a right side view of a second exemplary embodiment of the upright wheeled walker of this invention having four wheel assemblies each defining one of the four vertices of a polygonal walker footprint;

FIG. 4 is a top view of the walker embodiment of FIG. 1 illustrating the operation of several exemplary obstacle sensor embodiments responsive to several exemplary nearby obstacles in accordance with this invention;

FIG. 5 is an oblique view of the upper body supporting elements of the walker embodiment of FIG. 1 illustrating an exemplary embodiment of a plurality of handle and armrest kinetic motors suitable for providing haptic feedback signals to the user in accordance with this invention;

FIG. 6 is an oblique view of the upper body supporting elements of FIG. 5 illustrating exemplary dispositions of a graphical User Interface (GUI), processor assembly and user sensing camera suitable for use with the walker of this invention;

FIGS. 7A-B illustrates exemplary dispositions of haptic signaling elements and exemplary user hands and forearms while the user stands in a supported position within the footprint of the walker embodiment of FIG. 1;

FIGS. 8A-B are sketches illustrating exemplary embodiments of a forward-looking infrared (IR) obstacle sensor and an audio speaker suitable for use with the walker of this invention;

FIG. 9 is a functional block diagram of a first exemplary embodiment of a control system, including sensor output signals, processor signals, kinetic motor signals and kinetic motors, suitable for use with the walker of this invention;

FIG. 10 is a functional block diagram of a second exemplary embodiment of a control system, including sensor output signals, processor signals, kinetic motor signals and kinetic motors, suitable for use with the walker of this invention;

FIG. 11 is a schematic diagram of an exemplary infrared obstacle sensor detector circuit known in the art that is suitable for use with the walker of this invention;

FIG. 12 is a schematic diagram of an exemplary sensor detection circuit known in the art that is suitable for use with the walker of this invention;

FIG. 13 is a close-up oblique view of an exemplary left front wheel assembly embodiment from the upright wheeled walker of FIG. 1, including a hydraulic brake disk and caliper housing, suitable for use with the walker of this invention;

FIG. 14 is a schematic diagram of an exemplary electrohydraulic braking system embodiment suitable for use with the walker of this invention;

FIG. 15 is a close-up right side view of an exemplary right rear wheel assembly embodiment from the upright wheeled walker of FIG. 3, including a circumferential brake disk and braking element housing, suitable for use with the walker of this invention;

FIG. 16 is a cross-sectional view of an exemplary embodiment of a circumferential braking system for the upright wheeled walker of FIG. 3, including a brake handle, hydraulic linkages and the circumferential disk and braking elements, suitable for use with the walker of this invention;

FIG. 17 is an oblique view of the circumferential braking system embodiment of FIG. 16, including the brake handle, hydraulic linkages and the circumferential disk and braking elements, suitable for use with the walker of this invention;

FIGS. 18A-B illustrates an exemplary embodiment of an electromechanical fail-safe user braking control apparatus suitable for use with the walker of this invention;

FIG. 19 is functional diagram illustrating an alternative embodiment of a Graphical User Interface (GUI) touch panel display suitable for use with the walker of this invention; and

FIGS. 20A-F are sketches illustrating several exemplary signal specifications, including an alternative haptic signal specification of haptic signal frequency versus obstacle distance, suitable for use with the walker of this invention.

### DETAILED DESCRIPTION OF THE EMBODIMENTS

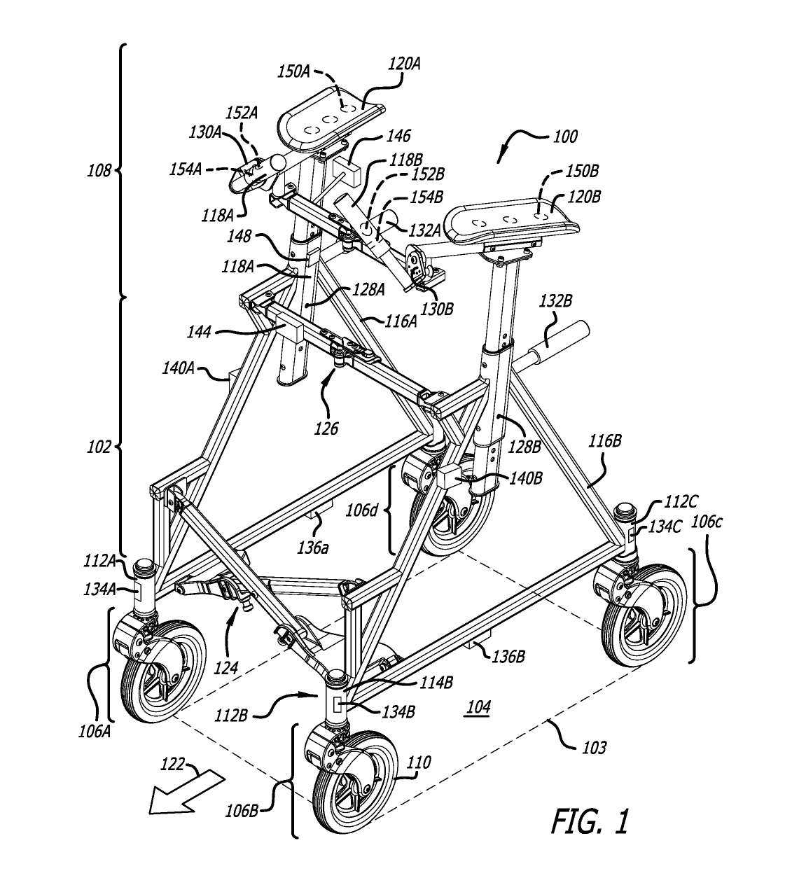

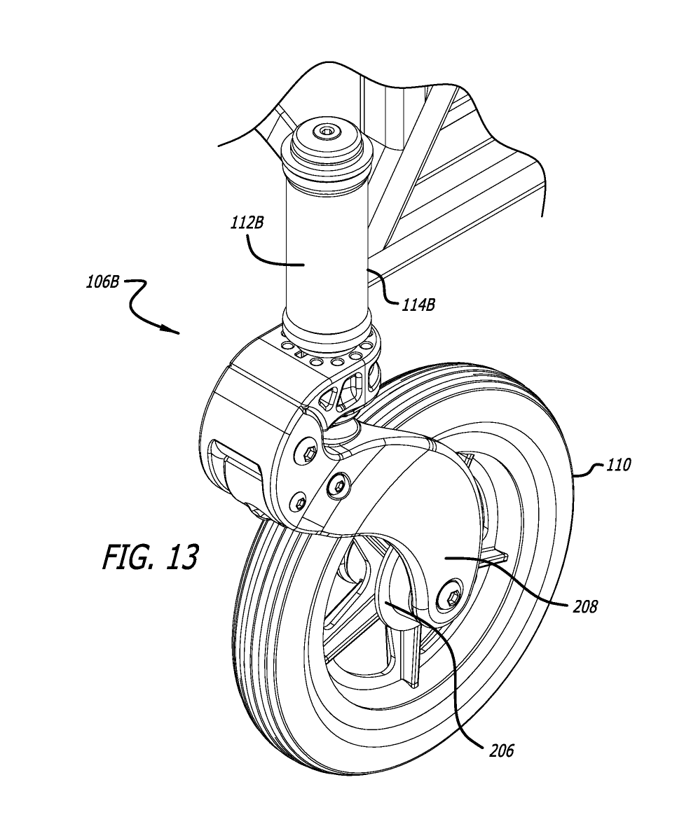

FIG. 1 shows a first exemplary embodiment of an upright wheeled walker 100 with a frame 102 supported above a surface 104 on four wheel assemblies 106A-D, which each define one of the (in this example) four vertices of a polygonal walker footprint 103 on surface 104, and with an upper body support assembly 108. Wheel assemblies 106A-D may be appreciated with reference to the left front wheel assembly 106B (see FIG. 13), which includes a wheel 110B and a wheel suspension assembly 112B that is fixed to frame 102 at a junction 114B. The polygonal walker footprint may, of course, be defined by three wheels located at three vertices or any larger number as well.

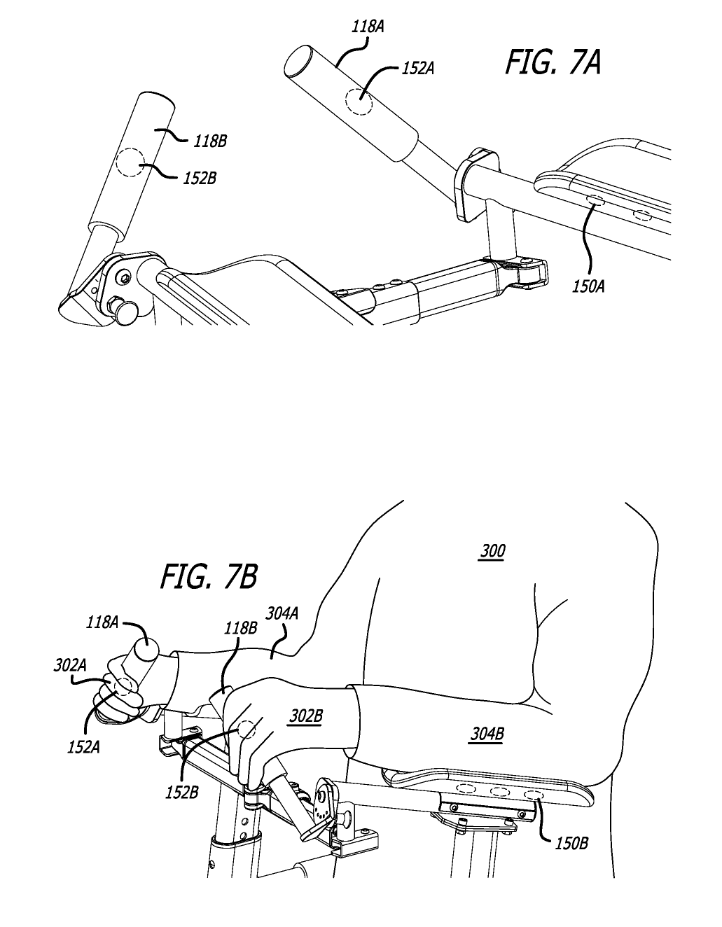

During use, a user 300 (see FIG. 7B) stands between the two anterior frame elements 116A-B within polygonal walker footprint 103 and grasps each of the upper handles 118A-B with a respective hand 302A-B (FIG. 7B) while resting a respective forearm 304A-B (FIG. 7B) in each of the armrest gutters 120A-B, thereby resting at least some weight on upright wheeled walker 100 and surface 104. The user may then walk forward in the direction shown by the arrow 122 as upright wheeled walker 100 rolls over surface 104 while supporting at least some weight, thereby assisting the user to walk over surface 104.

FIG. 1 also illustrates an X-folder element 124 and an upper folder element 126 that are useful for collapsing upright wheeled walker 100 for convenient storage and transportation. The elevation adjusters 128A-B are useful for adjusting the elevation of upper body support assembly 108 above surface 104 for a particular user height and each of the angle adjusters 130A-B are useful for adjusting the angle of the respective upper handle 118A-B. The lower handles 132A-B are useful for several purposes such as providing user support when arising from a seated position (not shown), for example.

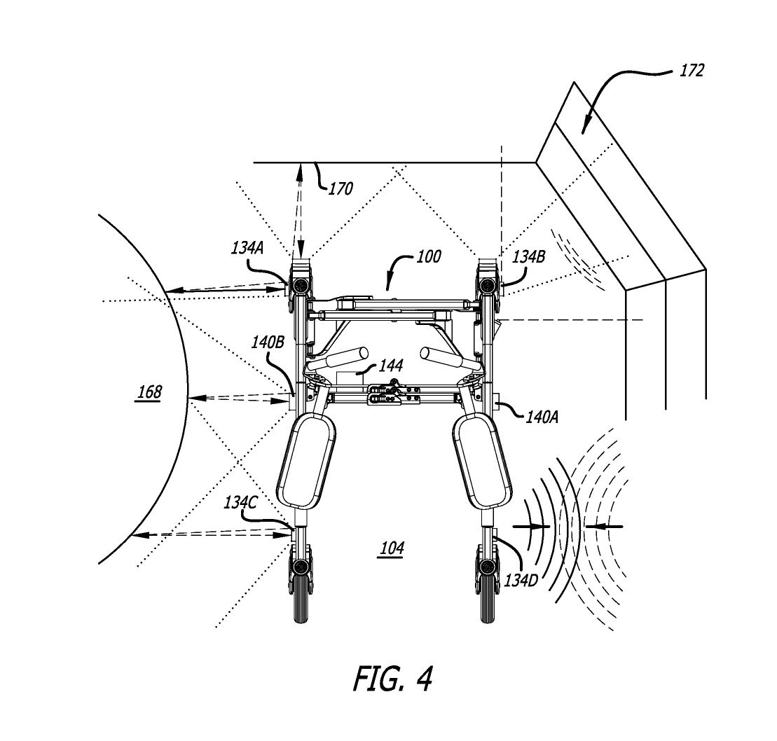

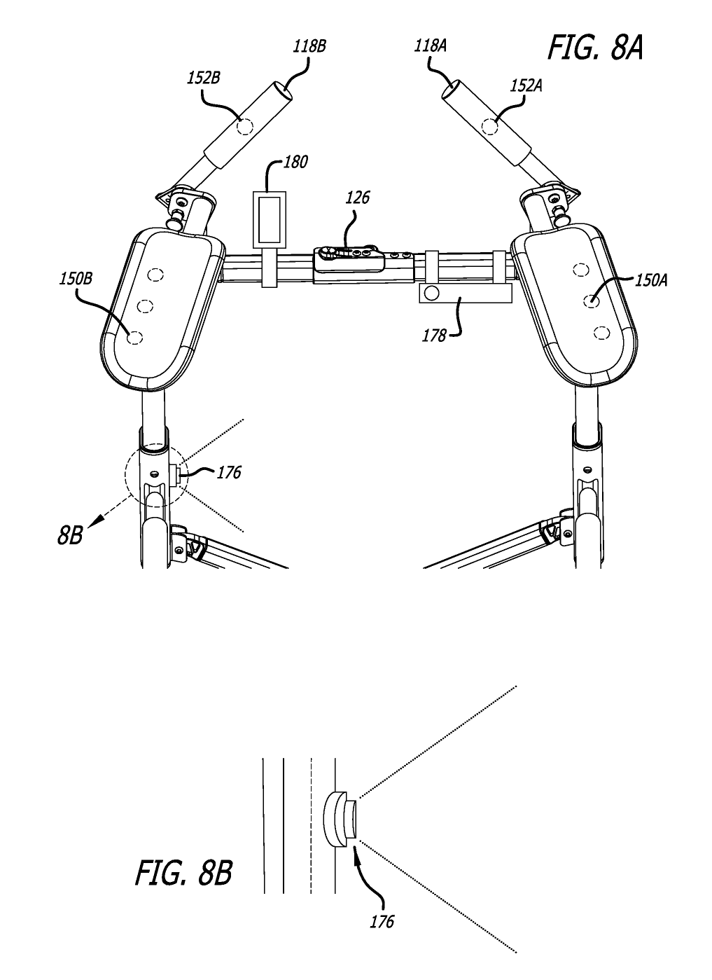

FIG. 1 also shows exemplary dispositions for the various sensor, processor and control elements of walker 100. For example, several small microwave Doppler sensors 134A-D are shown (see also FIG. 4) attached to a respective wheel suspension assembly exemplified by the microwave Doppler sensor 134B shown attached to wheel suspension assembly 112B. And the incline sensors 136A-B are each shown attached to a respective lower frame element 138A-B to detect longitudinal tilting of lower frame elements 138A-B. The 3D infrared (IR) sensors 140A-B are each shown attached to a respective posterior frame element 142A-B to detect mid-level obstacles. A system controller assembly 144 is shown attached to one side of upper folder element 126 in a disposition permitting folding (not shown) of the walker without interference. A Graphical User Interface (GUI) display 146 is disposed within convenient reach of the user and a loud-speaker (not shown) for emitting audio signals to the user may also be provided nearby (see FIG. 8A, for example). A simple optical sensor 148 is shown attached to upper body support assembly 108 in a position that operates as a user sensing means for producing a user detection signal responsive to a user disposed properly within the polygonal walker footprint.

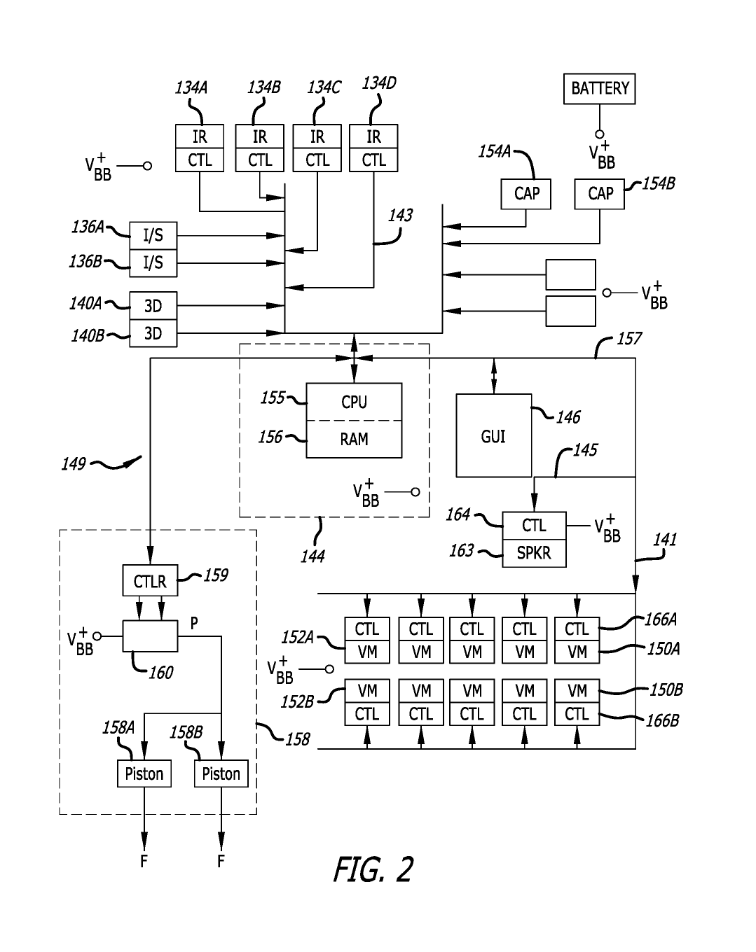

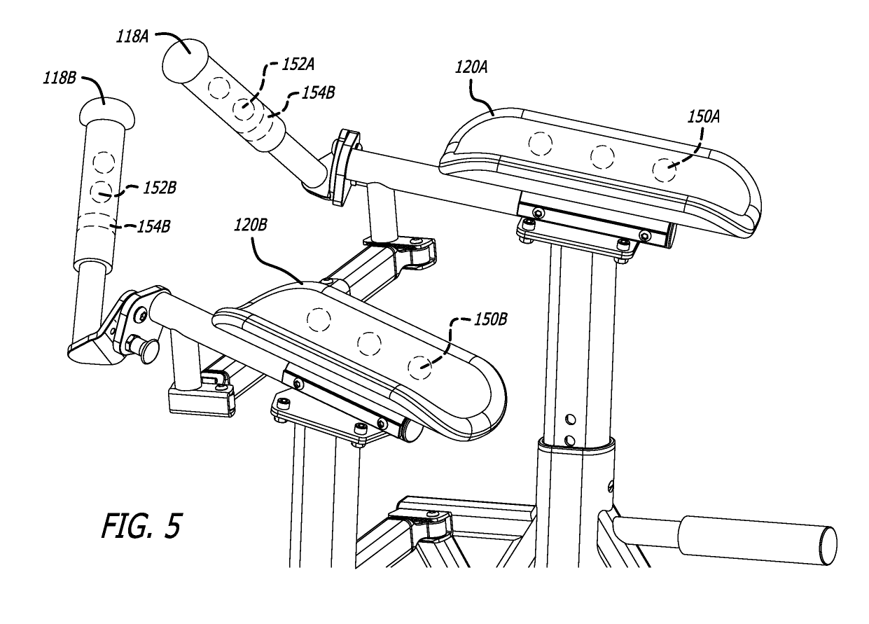

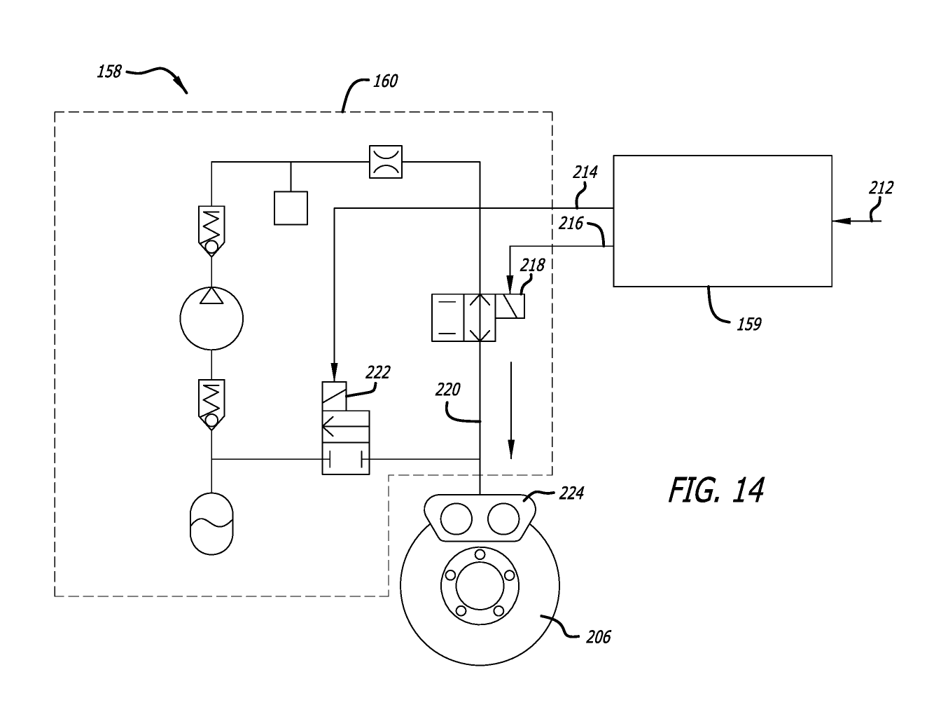

Finally, FIG. 1 shows an exemplary disposition of a plurality of kinetic motors, exemplified by the kinetic motor 150A in right armrest gutter 120A, the kinetic motor 150B in left armrest gutter 120B, the kinetic motor 152A in right upper handle 118A and the kinetic motor 152B in left upper handle 118B (see also FIG. 5). According to this invention the kinetic motors are disposed to provide haptic signaling to the user for a variety of purposes, such as alerting the user to obstacles and terrain hazards, suggesting a steering operation, for example. Similarly, the handle touch sensors 154A-B are each shown disposed on a respective upper handle 118A-B to produce a user touch signal responsive to touching of the respective upper handle 118A-B by the user. According to this invention, this user touch signal may be used in a user safety controller (FIG. 2) to operate an automatic electrohydraulic braking system (FIGS. 13-14), for example.

The various signal and power connections among the various sensor, processor and control elements attached to walker 100 are not shown in FIG. 1 but may be appreciated with reference to the following FIGS. 2-20.

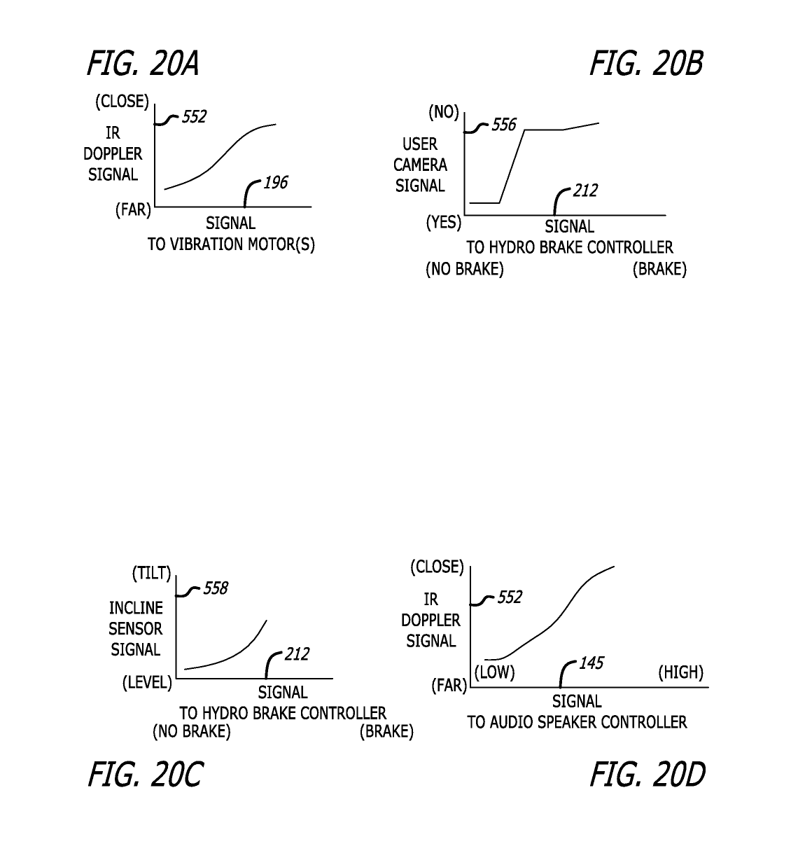

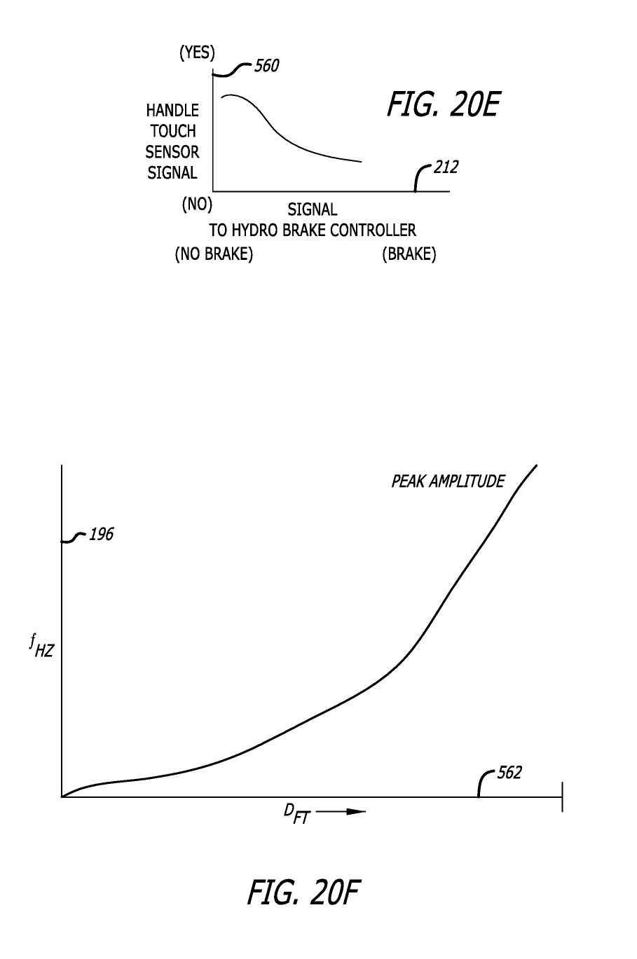

FIG. 2 is a functional block diagram of an exemplary walker control system embodiment 149 illustrating the relationship among several control system elements and signals provided for automatic obstacle avoidance and user safety in an exemplary walker embodiment. The various elements are labeled with the numerals used above with respect to FIG. 1. Additionally, system controller assembly 144 includes a microprocessor 155, with a Random Access Memory (RAM) 156 coupled by means of a digital data bus 157 to GUI 146 and the other elements substantially as shown. One such element is the electrohydraulic braking system 158 coupled to data bus 157, which includes a braking controller 159, a hydraulic system 160 for producing pressure in a hydraulic line 161, and a plurality of caliper pistons 162A-B each disposed to impose a braking force on a respective caliper assembly (see FIGS. 13-14). Handle touch sensors 154A-B are each shown producing a user touch signal that is coupled to microprocessor 155 by means of digital data bus 157. Incline sensors 136A-B are each shown producing an incline detection signal that is coupled to microprocessor 155 by means of digital data bus 157. A plurality of kinetic motors exemplified by kinetic motors 150A-B and 152A-B are disposed (FIG. 1) to produce a haptic sensation in the user responsive to a user alert signal 141 transferred on digital data bus 157. Microwave Doppler sensors 134A-B and 3D IR sensors 140A-B each produce a respective obstacle detection signal exemplified by the obstacle detection signal 143, which is also transferred on digital data bus 157 to microprocessor 155 for use in computing user alert signal 141. A loudspeaker 163 may be coupled through an audio controller 164 to data bus 157 for creating audio response to a second user alert signal 145 as desired. User alert signals 141 and 145 are produced by microprocessor 155 according to a stored program from RAM 153 responsive to the several sensor output signals exemplified by obstacle detection signal 143 (see also FIGS. 20A-F).

Finally, FIG. 2 shows the plurality of kinetic motors exemplified by kinetic motors 150A-B to each include a respective haptic controller 166A-B to facilitate coupling to user alert signal 141 presented on data bus 157.

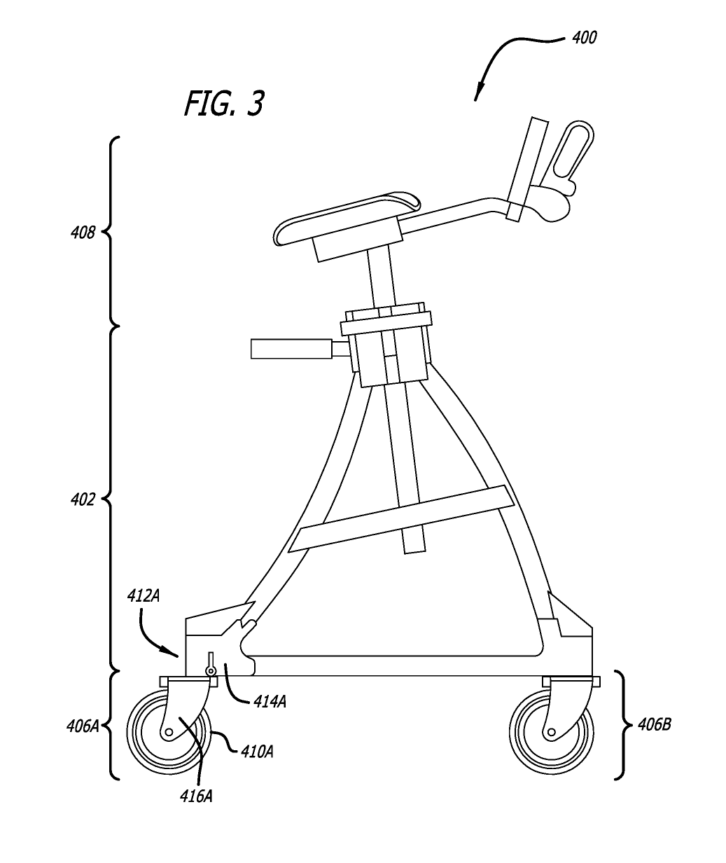

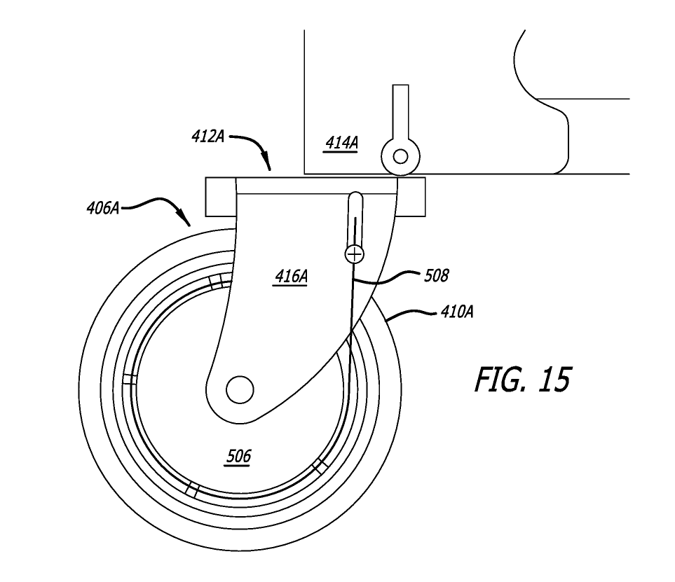

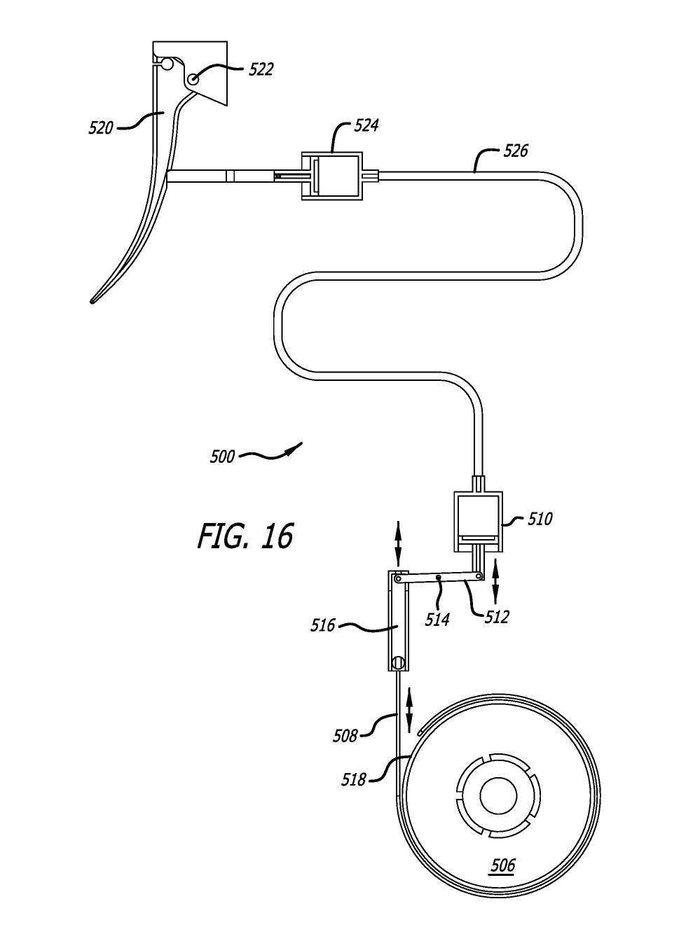

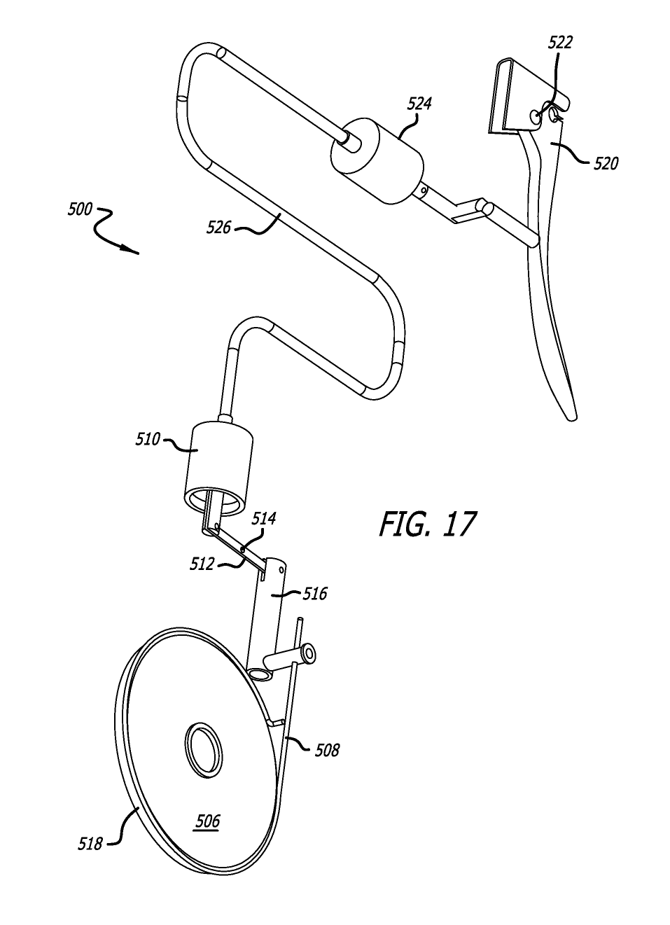

FIG. 3 shows a second exemplary embodiment of an upright wheeled walker 400 with a frame 402 supported above a surface on four wheel assemblies exemplified by wheel assemblies 406A-B, which each define one of a plurality of vertices of a polygonal walker footprint on a surface (see the above discussion of FIG. 1), and with an upper body support assembly 408. The four wheel assemblies, exemplified by the visible wheel assemblies 406A-B in FIG. 3, may be better appreciated with reference to FIG. 15 detailing right rear wheel assembly 406A, which includes a wheel 410A and a wheel suspension assembly 412A that is fixed to frame 402 at a junction 414A. The circumferential brake housing 416A housed and partially conceals a circumferential brake disk 506 and a circumferential braking element 508 that are discussed below in connection with FIGS. 16-17.

FIG. 4 illustrates the operation of the obstacle avoidance features of upright wheeled walker 100 mentioned above in connection with FIG. 2 and described in more detail hereinbelow. The various elements are labeled with the numerals used above with respect to the discussion of FIG. 1. Exemplary obstacles and hazards such as a curved wall 168, a curb 170 and a stairway 172 are illustrated to improve appreciation of the function and operation of Doppler microwave sensors 134A-D and 3D infrared (IR) sensors 140A-B.

FIG. 5 is an oblique view of the upper body supporting elements of the walker embodiment of FIG. 1 illustrating an exemplary disposition of the plurality of upper handle touch sensors 154A-B, upper handle kinetic motors 152A-B and armrest gutter kinetic motors 150A-B suitable for providing haptic feedback signals to the user grasping upper handles 118A-B during use.

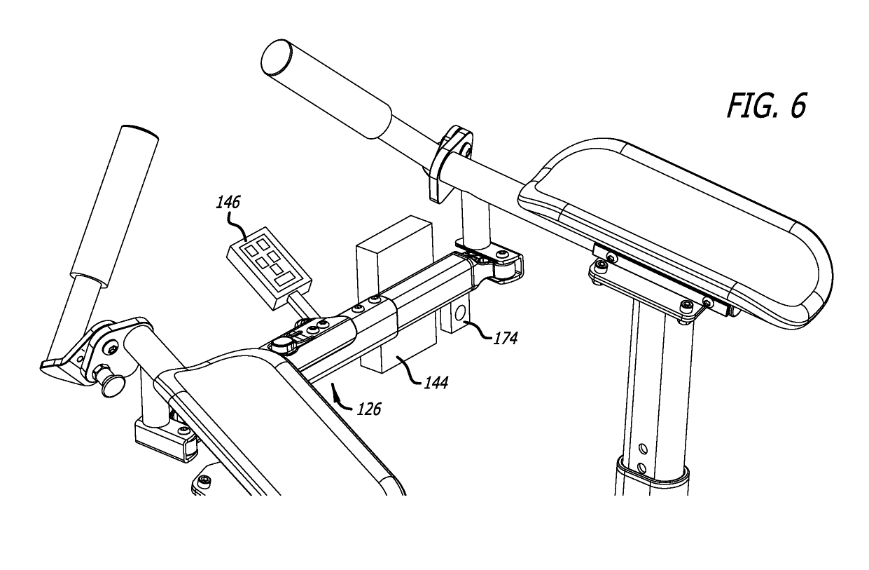

FIG. 6 is an oblique view of the upper body supporting elements of FIG. 5 illustrating exemplary dispositions of GUI display 146, processor 144 and a user sensing camera 174 on upper folder element 126 for producing a user detection signal.

FIG. 7A illustrates a closer view of upper handle kinetic motors 152A-B and armrest gutter kinetic motor 150A from FIGS. 1 and 5 for providing haptic feedback signals to the user. FIG. 7B shows how the user 300 may engage these haptic feedback elements with hands 302A-B and forearms 304A-B while standing and walking within the polygonal walker footprint (see also FIGS. 1 and 5).

FIGS. 8A-B show other exemplary embodiments and dispositions of a forward-looking infrared (IR) obstacle sensor 176 (directed along the arrow 122 in FIG. 1), a system controller and speaker assembly 178 and a cell phone GUI display 180 suitable for use with the walker of this invention. GUI display 180 may be embodied with, for example, an iOS or Android cell phone OS and connected to system controller and speaker assembly 178 with, for example, a data cable, a Bluetooth link or a Wi-Fi link (not shown). A dedicated software application (a Walker App, for example) may be adapted to log and track bioinformatics and link to a central server (not shown). The relevant bioinformatics database maybe maintained on a remote or local server including hosting and load balancing functionality. Biometric data collected from the user may be provided by external or internal user devices and transmitted to, for example, a Walker App hosted in the cell phone comprising GUI display 180.

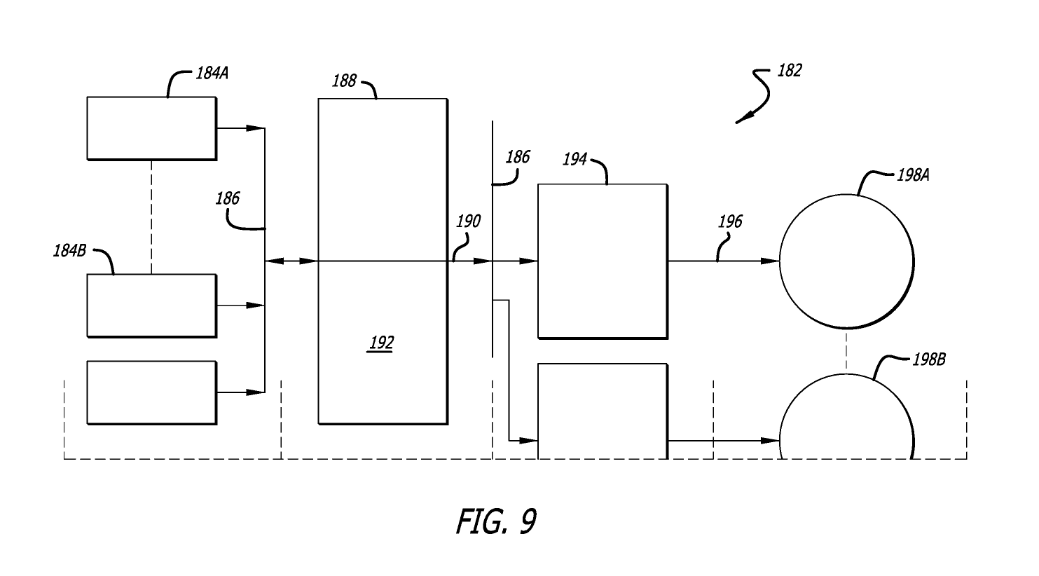

FIG. 9 is a block diagram illustrating the operation of a first alternative walker control system embodiment 182. A plurality of walker sensors each produce a digital sensor output signal, exemplified by the digital sensor output signal 184A, responsive to a respective sensor input (not shown), such as an input to (see FIGS. 1-2) optical sensor 148, handle touch sensor 154A, incline sensor 136A or Doppler microwave sensor 134A, for example without limitation. These digital sensor output signals are coupled by means of a data bus 186 to the microprocessor 188 in any useful manner known in the art. Microprocessor 188 produces a digital control output signal 190 responsive to the digital sensor input signals on data bus 186 according to program instructions (not shown) stored in a RAM 192. Digital control output signal 190 is transferred by data bus 186 to a kinetic motor driver 194, which produces a kinetic motor driver signal 196. Kinetic motor driver signal 196, which may be an analog voltage, for example, is applied to a kinetic motor 198A to produce a vibration wave responsive to driver signal 196. As described above, kinetic motor 198A is disposed in an armrest gutter or an upper handle whereby the vibration wave will be felt by the user in hand or forearm as a haptic feedback signal (see also FIGS. 2, 5, and 7B) alerting the user according to the features of the stored program in RAM 192.

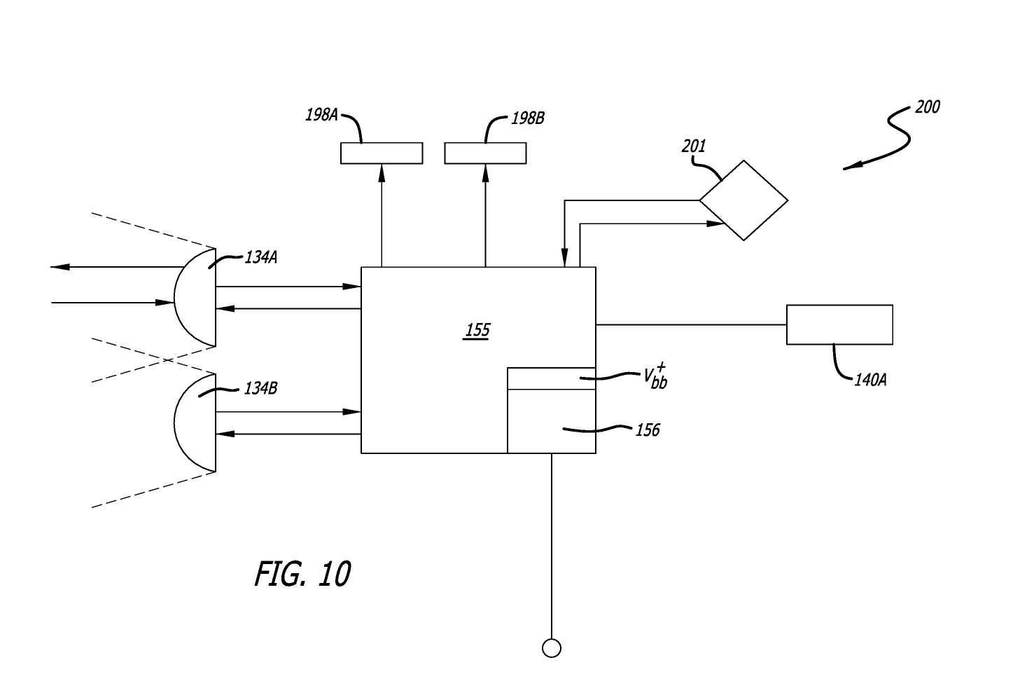

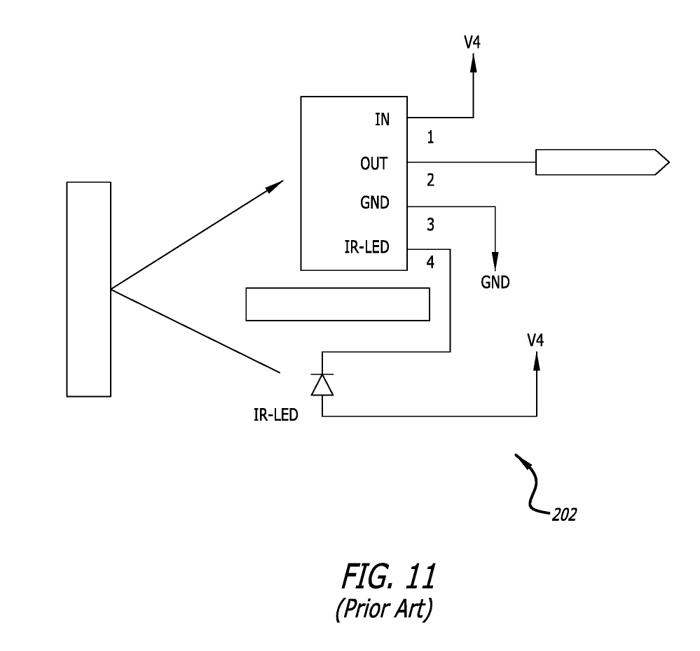

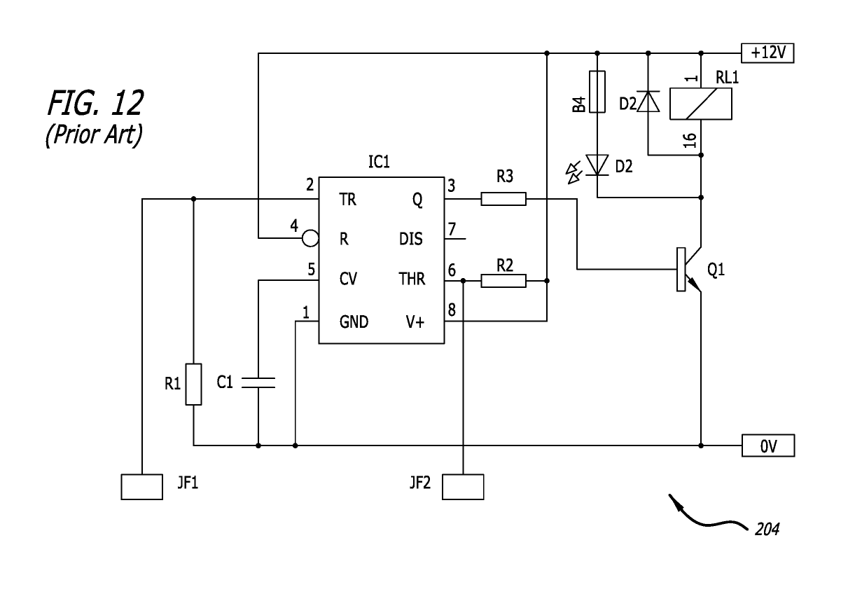

FIG. 10 illustrates the operation of a simpler walker control system embodiment 200, showing kinetic motors 198A-B, microwave Doppler sensors 134A-B, microprocessor 155, RAM 156, 3D infrared (IR) sensor 140A and a speed-sensitive braking control system the operation of which may be appreciated with reference to the above discussion of FIG. 2 and the discussion below. FIG. 11 illustrates an exemplary sensor embodiment 202 known in the art that is suitable for use with the walker of this invention. FIG. 12 illustrates an exemplary sensor detection circuit embodiment 204 known in the art that is suitable for use with the walker of this invention.

FIG. 13 shows the detail of wheel assembly 106B (FIG. 1) to better illustrate the hydraulic brake disk 206 and the brake caliper housing 208.

FIG. 14 shows the functional operation of electrohydraulic braking system 158 (FIG. 2). System controller assembly 144 (FIG. 2) produces the digital braking control signal 212 on data bus 157 (FIG. 2), which is received by braking controller 159. Braking controller 159 produces a brake release signal 214 and a braking signal 216 responsive to digital braking control signal 212. Signals 214 and 216 may be analog voltages, for example, and each operates a respective hydraulic valve in hydraulic system 160 as follows. Braking signal 216 operates the apply valve 218 to increase the hydraulic pressure in the brake line 220 and brake release signal 214 operates the release valve 222 to reduce the pressure in brake line 220, thereby closing or opening the brake calipers 224 by moving a piston exemplified by piston 158A (FIG. 2), thereby seizing or releasing hydraulic brake disk 206 in the usual manner.

FIG. 15 shows the details of wheel assembly 406A (FIG. 3) to better illustrate partially-visible circumferential brake disk 506 and circumferential braking element 508 rendered visibly within a partially-transparent rendering of housing 416A.

FIG. 16 is a schematic cross-sectional view of an exemplary embodiment of a circumferential braking system 500 of this invention. Circumferential braking element 508 engages with the outer rim 518 of circumferential braking element 508 in the manner shown. Increasing the pressure in a hydraulic chamber 510 forces one side of a lever arm 512 down-ward about the fixed axis 514, the other side of lever arm 512 urges the coupler 516 upward, drawing circumferential braking element 508 upward to tighten the grip about outer rim 518 of circumferential brake disk 508. This tightening operates to brake wheel 410A (FIGS. 3 and 15) by means of the increased friction between outer rim 518 and circumferential braking element 508 in the usual manner. Reducing or releasing the pressure in hydraulic chamber 510 reverses this process and releases the brake at wheel 410A. User control of circumferential braking system 500 is accomplished by touching and moving the handle 520 about the hinge 522 in a well-known manner to increase the pressure in the hydraulic chamber 524, which pressure is transferred through the hydraulic line 526 in communication with hydraulic chamber 510. In this manner, user movement of handle 520 controls the pressure in hydraulic chamber 510, and the braking of wheel 410A.

FIG. 17 provides a schematic oblique view of circumferential braking system 500 of FIG. 16 to better illustrate the functional relationship among the various elements discussed above in connection with FIG. 16. Any other suitable element for transferring force or power, such as cables or electrical power transfer means, for example without limitation, may also be used instead of the exemplary hydraulic elements (e.g., 510, 524 and 526) illustrated in FIGS. 16-17, as will be readily appreciated by those skilled in the art.

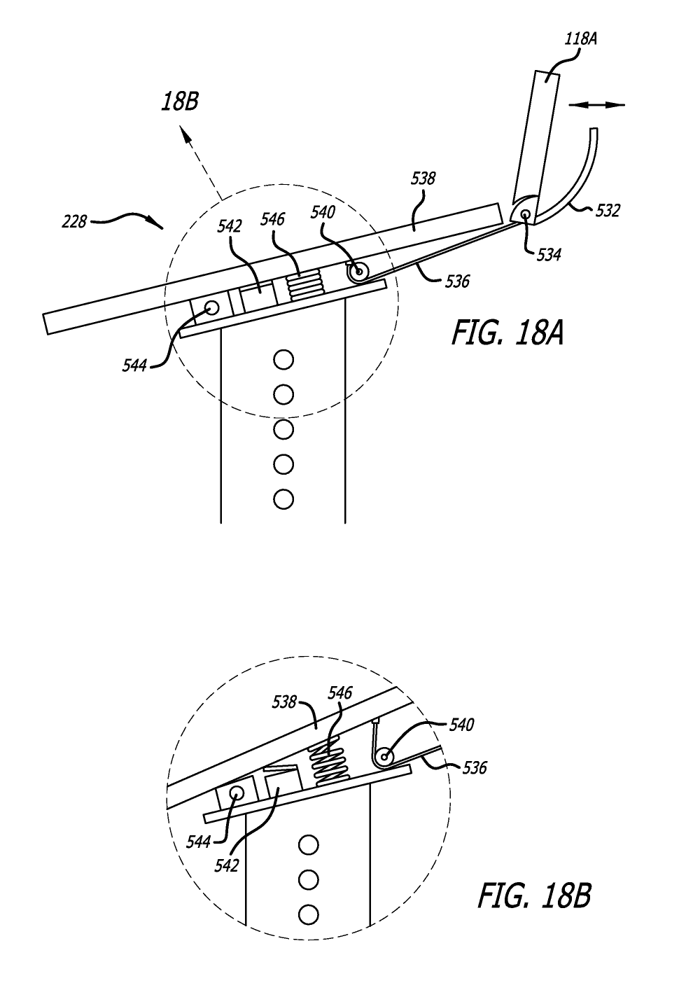

FIGS. 18A-B illustrates an exemplary embodiment of an electromechanical fail-safe braking control 228. In one manner of operation, the user (not shown) grips a handle 118A (e.g., FIGS. 7A-B) and squeezes the brake handle 532 to force it to turn about the hinge 534 and pull the cable element 536 attached to the underside of a rocker arm 538. When squeezed by the user, handle 532 draws cable 536 about a pulley 540 to force rocker arm 538 down against a fail-safe switch 542 while rotating about the hinge 544 and compressing the spring element 546. Fail safe switch 542 is useful for signaling a braking system (for example, electrohydraulic braking system 158 in FIG. 14) to apply braking signal 216 when open and brake release signal 214 when closed to control the wheel brakes in an upright wheeled walker, for example. Referring to FIG. 18A, fail-safe switch 542 is shown closed under pressure from rocker arm 538, which is shown depressed against spring element 546 by the combination of user forearm weight and a user touch (not shown) on brake handle 532. Referring to FIG. 18B, fail-safe switch 542 is shown open as rocker arm 538 is forced upward by spring element 544 because of the release of all user forearm weight and user touch on brake handle 532. In another manner of operation, if spring 546 is selected to be sufficiently weak, the weight and pressure of a user forearm (not shown) on top of rocker arm 538 may alone be useful to urge closure of fail-safe switch 542 with no need for a user grip on handle 532. Either method may serve to control a fail-safe braking system to ensure that upright walker wheel brakes cannot be released without a user grip on brake handle 532 or a user forearm force on rocker arm 538 or some combination thereof.

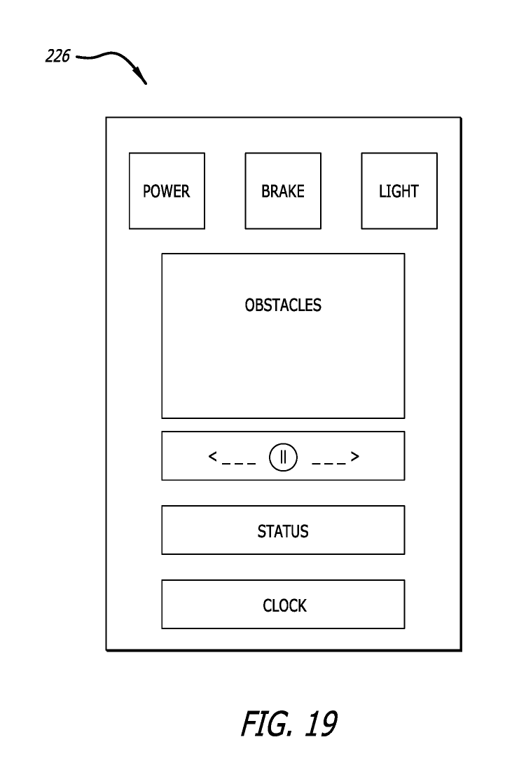

FIG. 19 illustrates an alternative GUI touch panel display 226 suitable for use with the walker of this invention.

FIGS. 20A-F illustrate several exemplary signal processing specifications suitable for use with system controller 144 (FIG. 2) and each specification may be implemented in the program instructions stored in RAM 156, for example. These signal specification examples are neither exhaustive nor exclusive. FIG. 20A illustrates an exemplary relationship between the obstacle detection signal 552 from Doppler microwave sensor 134A (FIG. 1) and kinetic motor driver signal 196 to kinetic motors 150A-B and 152A-B in the handles and armrest gutters. FIG. 20B illustrates an exemplary relationship between the user detection signal 556 from optical sensor 148 and digital braking control signal 212. FIG. 20C illustrates an exemplary relationship between the incline detection signal 558 from incline sensor 136A and digital braking control signal 212. FIG. 20D illustrates an exemplary relationship between output signal 552 from Doppler microwave sensor 134A (FIG. 1) and user alert signal 145 (FIG. 2) to speaker 163. FIG. 20E illustrates an exemplary relationship between a user touch signal 560 from handle touch sensor 154A and digital braking control signal 212. FIG. 20F illustrates an exemplary relationship between the frequency of kinetic motor driver signal 196 and the computed obstacle distance derived from a sensor output signal combination 562 from obstacle sensors such as Doppler microwave sensors 134A or 3D infrared (IR) sensors 140A, for example.

Clearly, other embodiments and modifications of this invention may occur readily to those of ordinary skill in the art in view of these teachings. Therefore, this invention is to be limited only by the following claims, which include all such embodiments and modifications when viewed in conjunction with the above specification and accompanying drawing.

1. A wheeled walker for a user having one or more hands and forearms, compris a frame having a front and a rear,
an upper body support assembly coupled to the frame, including
gutter means for supporting the one or more user forearms, and
handle means for touching by the one or more user hands;
a plurality of wheel assemblies coupled to the frame and disposed to support the frame on a surface and to define a polygonal footprint on the surface, each wheel assembly disposed at a vertex of the polygonal footprint and including
one or more rear wheel assemblies disposed generally at the rear of the frame and each including a wheel, and
one or more front wheel assemblies disposed generally at the front of the frame and each including a wheel;
first sensing means disposed to produce an obstacle detection signal responsive to the presence of an obstacle in the vicinity of the wheeled walker;
first processing means coupled to the first sensing means for producing a user alert signal responsive to the obstacle detection signal; and
kinetic means coupled to the first processing means and disposed in the upper body support assembly to produce a haptic sensation in the user responsive to the user alert signal.

2. The wheeled walker of claim 1 further comprising:
in one or more of the wheel assemblies, a wheel brake disposed to brake the wheel;
second processing means coupled to the touch sensing means for producing a braking control signal responsive to the user alert signal; and
braking control means coupled to the second processing means for engaging and for releasing the wheel brake responsive to the braking control signal.

3. The wheeled walker of claim 1 further comprising:
in one or more of the wheel assemblies, a wheel brake disposed to brake the wheel;
touch sensing means disposed to produce a user touch signal responsive to contact by a user hand with the handle means;
second processing means coupled to the touch sensing means for producing a braking control signal responsive to the user touch signal; and
braking control means coupled to the second processing means for engaging and for releasing the wheel brake responsive to the brake control signal.

4. The wheeled walker of claim 1 further comprising:
in one or more of the wheel assemblies, a wheel brake disposed to brake the wheel;
incline sensing means disposed to produce an incline detection signal responsive to the difference in elevation between the front and rear wheel assemblies;
second processing means coupled to the incline sensing means for producing a braking control signal responsive to the incline detection signal; and
braking control means coupled to the second processing means for engaging and for releasing the wheel brake responsive to the brake control signal

5. The wheeled walker of claim 1 further comprising:
in one or more of the wheel assemblies, a wheel brake disposed to brake the wheel,
user sensing means disposed to produce a user detection signal responsive to the visible presence of the user within the polygonal footprint;
second processing means coupled to the user sensing means for producing a braking control signal responsive to the user detection signal; and
braking control means coupled to the second processing means for engaging and for releasing the wheel brake responsive to the brake control signal.

6. The wheeled walker of claim 1 further comprising:
in one or more of the wheel assemblies, a wheel brake disposed to brake the wheel,
touch sensing means disposed to produce a user touch signal responsive to contact by a user hand with the handle means;
incline sensing means disposed to produce an incline detection signal responsive to the difference in elevation between the front and rear wheel assemblies;
second processing means coupled to the touch sensing means and the incline sensing means for producing a braking control signal responsive to a combination of the user touch signal and the incline detection signal; and
braking control means coupled to the second processing means for engaging and for releasing the wheel brake responsive to the brake control signal

7. The wheeled walker of claim 1 further comprising:
in one or more of the wheel assemblies, a wheel brake disposed to brake the wheel,
touch sensing means disposed to produce a user touch signal responsive to contact by a user hand with the handle means;
incline sensing means disposed to produce an incline detection signal responsive to the difference in elevation between the front and rear wheel assemblies;
user sensing means disposed to produce a user detection signal responsive to the visible presence of the user within the polygonal footprint;
second processing means coupled to the touch sensing means and the incline sensing means and the user sensing means for producing a braking control signal responsive to a combination of the user touch signal and the incline detection signal and the user detection signal; and
braking control means coupled to the second processing means for engaging and for releasing the wheel brake responsive to the brake control signal,

8. The wheeled walker of claim 1 wherein:
the gutter means includes one or more gutters each disposed to accept and support a user forearm.

9. The wheeled walker of claim 1 wherein:
the handle means includes one or more handles each disposed for touching by a user hand.

10. The wheeled walker of claim 1 wherein:
the kinetic means includes a kinetic motor disposed in the gutter means such that the haptic alert signal to a user forearm when present.

11. The wheeled walker of claim 1 wherein:
the kinetic means includes a kinetic motor disposed in the handle means such that the haptic alert signal is coupled to a user hand when present.
